(19) United States
(12) Patent Application Publication
(10) Pub. No.: US 2016/0063763 A1
(43) Pub. Date: Mar. 3, 2016

(54) IMAGE PROCESSOR AND INFORMATION PROCESSOR

(71) Applicant: KABUSHIKI KAISHA TOSHIBA, Tokyo (JP)

(72) Inventor: Hajime MATSUI, Yokohama Kanagawa (JP)

(21) Appl. No.: 14/643,317

(22) Filed: Mar. 10, 2015

(30) Foreign Application Priority Data
Aug. 26, 2014 (JP) 2014-171877

(51) Int. Cl. G06T 19/00; G06F 17/27; G06F 17/28; G06K 9/18; G06T 11/60

(52) U.S. Cl. CPC G06T 19/006; G06K 9/18; G06T 11/60; G06F 17/28; G06F 17/2735

(57) ABSTRACT

An image processor according to the present embodiment is an image processor for processing an image of an object visible through a transparent display. The image processor includes an acquisition unit and a controller. The acquisition unit acquires display information corresponding to the object and obtained by performing recognition processing on the image. The controller displays, on the transparent display, the display information.

### CROSS REFERENCE TO RELATED APPLICATIONS

This application is based upon and claims the benefit of priority from the prior Japanese Patent Application No. 2014-171877, filed on Aug. 26, 2014, the entire contents of which are incorporated herein by reference.

### FIELD

Embodiments relate to an image processor and an information processor for processing a captured image.

### BACKGROUND

Electronic dictionary terminals and electronic dictionary software have been more and more used to look up the meaning of a certain word or translate a certain word into another language. The user of the electronic dictionary terminal can automatically obtain search results by only inputting a word, instead of manually turning over the pages of a paper dictionary to look up the word. Further, when using electronic dictionary software, a word to be searched can be selected through copy & paste or mouse click, which leads to more effective dictionary search.

However, in the existing electronic dictionary terminals and electronic dictionary software, search results are displayed on the display screen of the electronic dictionary terminal, or on the screen of a computer running the electronic dictionary software, which inevitably requires the user to take his/her eyes from the paper he/she is reading to check the search results of a word. Since this may possibly reduce the user's concentration, ideas for further improving convenience are required.

### BRIEF DESCRIPTION OF THE DRAWINGS

FIGS. 1A and 1B are oblique perspective views of an information processor according to an embodiment.

FIGS. 2A, 2B, and 2C are oblique perspective views of an information processor according to an embodiment.

FIG. 3 is oblique perspective view of an information processor according to an embodiment.

FIG. 4A is a block diagram showing an example of the configuration of the information processor 100 according to an embodiment.

FIG. 4B is a block diagram showing an example of the internal structure of the acquisition unit 220.

FIG. 4C is a block diagram showing an example of the internal structure of the acquisition unit 220.

FIG. 5 is a flow chart for explaining the process performed by an information processor according to an embodiment.

FIG. 6 is a flow chart for explaining the process to acquire display information according to an embodiment.

FIG. 7 is a diagram showing an example of a display information on an information processor according to an embodiment.

### DETAILED DESCRIPTION

An image processor according to the present embodiment is an image processor for processing an image of an object visible through a transparent display. The image processor includes an acquisition unit and a controller. The acquisition unit acquires display information corresponding to the object and obtained by performing recognition processing on the image. The controller displays, on the transparent display, the display information.

Embodiment will now be explained with reference to the accompanying drawings.

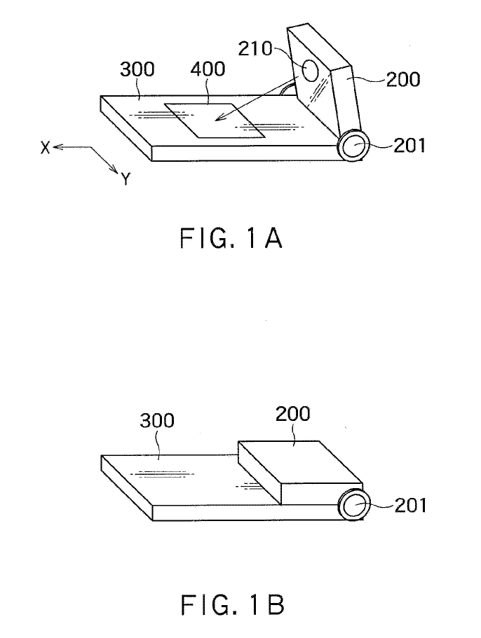

Each of FIGS. 1 to 3 is an oblique perspective view showing the configuration of an information processor 100 according to an embodiment. The information processor 100 of FIGS. 1 to 3 has a housing 200 having an image capture unit 210 which captures an object, and a transparent display 300. The housing 200 has an image processor incorporated therein. The concrete structure of the image processor will be mentioned later.

In the information processor 100, the image capture unit 210 captures an image of an object, which is at least a part of the image visible through the transparent display 300, and the housing 200 performs recognition processing on the captured image to acquire display information corresponding to the object so that image determined by this display information is displayed on the transparent display 300.

The image capture unit 210, which is, e.g., a CMOS sensor or a CCD sensor, is incorporated in the housing 200. The transparent display 300 displays an image of a sheet of paper etc. which is arranged directly beneath and visible through the transparent display 300. The image of an object is included in the image visible through the transparent display 300. The image capture unit 210 captures the image of the object through the transparent display 300. The transparent display 300 may display a range 400 within which the image capture unit 210 can capture the object, using a rectangular frame for example. Within the possible capturing range, the image capture unit 210 comes into focus, and the image of the object included within this range is treated as the target of image processing.

FIG. 1 shows an example where the housing 200 is supported to be rotatable with respect to the transparent display 300. FIG. 1A shows a state where the housing 200 is rotated so that the image capture unit 210 comes into focus on the surface of the transparent display 300, and FIG. 1B shows a state where the housing 200 is superposed on the surface of the transparent display 300. The housing 200, which can be superposed on the transparent display 300 as shown in FIG. 1B, is convenient to carry around when the image capture unit 210 captures no image. The housing 200 is rotatable around a rotating shaft 201 extending along one side of the transparent display 300.

In order that the image capture unit 210 vividly captures the image visible through the transparent display 300, the image capture unit 210 must come into focus on the surface of the transparent display 300. However, the distance between the image capture unit 210 and the transparent display 300 changes depending on the rotational angle of the housing 200. Thus, a click mechanism may be applied to the rotating shaft 201 and its bearing so that the housing 200 can be temporarily fixed when the image capture unit 210 comes into focus on the surface of the transparent display 300 with an appropriate rotational angle.

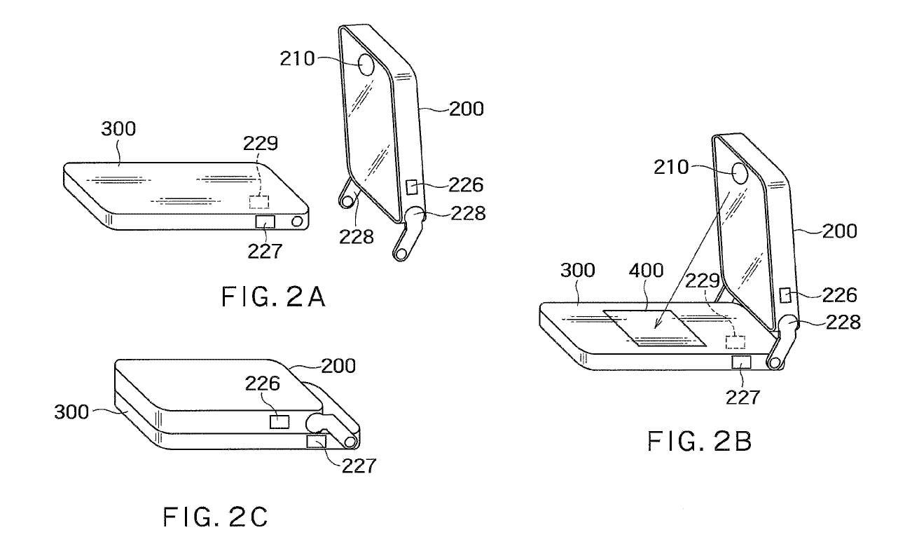

On the other hand, the housing 200 of FIG. 2 is removable from the transparent display 300. FIG. 2A shows a state where the housing 200 is removed from the transparent display 300, FIG. 2B shows a state where the image capture unit 210 is set at a rotational angle which enables the image capture unit 210 to come into focus on the surface of the transparent display 300, and FIG. 2C shows a state where the housing 200 is superposed on the surface of the transparent display 300. When the image capture unit 210 captures no image, the housing 200 may be separated from the transparent display 300 as shown in FIG. 2A, or may be superposed on the transparent display 300 as shown in FIG. 2C.

The housing 200 of FIG. 2 is connected to the transparent display 300 through support parts 228 removably attached to both ends of one side face of the housing 200. Since the support parts 228 are removable from the housing 200, a general-purpose communication terminal (e.g., cellular phone, smartphone, etc.) having the image capture unit 210 can be used as the housing 200.

Note that each support part 228 has protrusions at both ends thereof. The protrusion at one end is engaged with the housing 200, and the protrusion at the other end is engaged with the transparent display 300. Thus, each of the housing 200 and the transparent display 300 must have holes to engage these protrusions with the holes. After the protrusions at the other ends are engaged with the holes provided on the side faces of the transparent display 300, the housing 200 is rotatable with respect to the transparent display 300 through the support parts 228.

Note that the support parts 228 may be integrated into a cover which protects the outer surface of the housing 200. In this case, there is no need to provide the protrusions at one ends of the support parts 228, and to provide the holes on the housing 200. When the support parts 228 are integrally attached to the cover storing the housing 200, the protrusions at the other ends of the support parts are engaged with the transparent display 300, which makes it possible to rotate the housing with respect to the transparent display 300 similarly to FIG. 1.

In the case of FIG. 2, when the click mechanism is applied to the protrusions of the support parts 228, rotation of the support parts 228 can be temporarily stopped when the rotational angle of the housing 200 with respect to the transparent display 300 is set at a predetermined angle, which enables the image capture unit 210 to come into focus on the surface of the transparent display 300.

As stated above, even when the image capture unit 210 comes into focus on the surface of the transparent display 300, the range within which the image capture unit 210 can vividly capture an image is limited. Thus, a frame showing the range 400 within which the object can be extracted may be displayed on the surface of the transparent display 300. This frame may be displayed on the transparent display 300 based on an image signal from the housing 200, or may be previously printed on the surface of the transparent display 300.

The image signal from the housing 200 is wirelessly transmitted to the transparent display 300. In this case, e.g.,

Bluetooth (registered trademark) is used as a wireless method, but another wireless method may be employed instead.

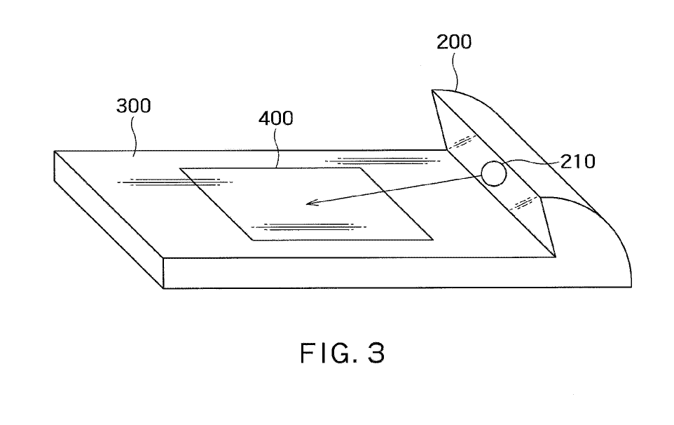

On the other hand, in FIG. 3, the positional relationship between the housing 200 and the transparent display 300 is fixed. Omitting the rotational mechanism and removal mechanism from the housing 200 in this way makes it possible to reduce production cost and to improve durability of the product. Further, the housing 200, if having a lower height, does not remarkably deteriorate portability. Note that simply lowering the height of the housing 200 may possibly narrow the range within which the image capture unit 210 comes into focus on the captured image, but this problem of narrowing the focusable range will disappear by exercising ingenuity on the focusing of the image capture unit 210 as mentioned later.

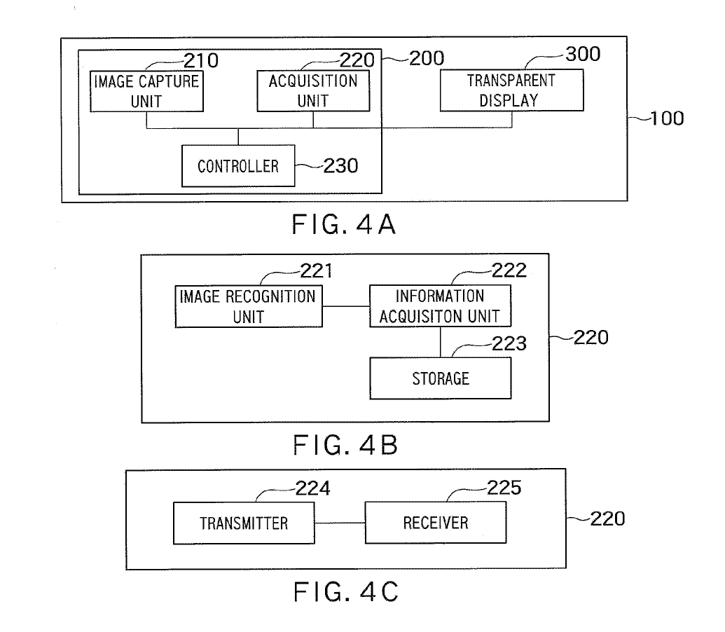

FIG. 4A is a block diagram showing an example of the configuration of the information processor 100 according to an embodiment. The information processor 100 has the housing 200 and the transparent display 300. The housing 200 has the image capture unit 210, an acquisition unit 220, and a controller 230. The image processor incorporated in the housing 200 includes at least the acquisition unit 220 and the controller 230.

Next, each component shown in FIG. 4A will be explained in detail below.

### (Image Capture Unit 210)

The image capture unit 210 captures an image of an object visible through the transparent display 300, and converts it into image data. This image capture unit 210 may have functions for changing the capture range and focus using a lens and electronic zoom. Instead, the image capture unit 210 may have a single focus lens.

In FIG. 1, the range 400 on the surface of the transparent display 300 shows the focusable range of the image capture unit 210, within which the image data is acquired. Instead, the image capture unit 210 may synthesize a plurality of images captured at different focus points to acquire image data which is in focus on the whole of the transparent display 300. In this case, the range 400 entirely covers the transparent display 300, which eliminates the need to display the frame showing the range 400. Note that the image capture unit 210 captures at least one of a moving image and a still image.

### (Acquisition Unit 220)

FIG. 4 B is a block diagram showing an example of the internal structure of the acquisition unit 220. The acquisition unit 220 has an image recognition unit 221, an information acquisition unit 222, and a storage 223. This image recognition unit 221 performs recognition processing on the image data to obtain identification information of the object. The storage 223 previously stores display information corresponding to each of plural pieces of identification information. The information acquisition unit 222 acquires, from the storage 223, display information corresponding to the identification information. In this way, the acquisition unit 220 acquires display information corresponding to the object and obtained by performing recognition processing on the image data.

Each component of the acquisition unit 220 shown in FIG. 4B will be explained in detail below.

### (Image Recognition Unit 221)

The image recognition unit 221 corrects distortion of the data of a captured image. For example, the image recognition unit 221 generates correction data by performing matching processing between a captured image of a calibration pattern visible through the transparent display 300 and an image of the pattern before being captured, and uses this correction data to correct the captured image. Such correction data is, e.g., an inverse projective transformation matrix showing the relationship between an image of a calibration pattern visible through the transparent display 300 and an image of the pattern before being captured. The image recognition unit 221 converts image data using this inverse projective transformation matrix to remove distortion caused through capturing.

When capturing images while variously changing the rotational angle of the housing 200 with respect to the transparent display 300, correction data corresponding to each rotational angle is previously acquired and stored.

Further, the image recognition unit 221 removes noise from the image data removed of distortion. At this time, it is possible to use any one of or both of a spatial denoising filter and a temporal denoising filter. Then, the image recognition unit 221 extracts object data using the image data removed of noise, and performs recognition processing to obtain identification information of the object. Here, the identification information means information related to the object. For example, if the object is a character string, the character string obtained through the image recognition is treated as the identification information.

Further, the image recognition unit 221 may generate supplementary information for controlling the display state and display position of the object on the transparent display 300.

### (Information Acquisition Unit 222)

The information acquisition unit 222 obtains, from the storage 223, display information corresponding to the identification information of the object and obtained by the image recognition unit 221.

### (Storage 223)

The storage 223 stores plural pieces of identification information and display information corresponding thereto. For example, the storage 223 stores display information of an English word corresponding to the identification information of an English character string. The display information in this case is a literal translation of the English word. That is, the storage 223 in this case is a relational database relating the literal translation to the display information corresponding to the identification information of the English word set as a primary key.

Note that the storage 223 can be formed as a nonvolatile memory such as a ROM, a flash memory, and a NAND-type memory. Further, for example, the storage 223 may be provided in an external device such as a server so that the information acquisition unit 222 accesses the storage 223 through a communication network such as Wi-Fi (registered trademark) and Bluetooth.

In the example shown in FIG. 4B, the acquisition unit 220 recognizes an image and acquires display information corresponding thereto. However, the recognition of the image and acquisition of the display information may be performed by a processing device such as a server (not shown) provided separately from the acquisition unit 220. The acquisition unit 220 in this case can be expressed as a block diagram of FIG. 4C, for example.

FIG. 4 C is a block diagram showing an example of the internal structure of the acquisition unit 220. The acquisition unit 220 of FIG. 4C has a transmitter 224 which transmits image data to the processing device, and a receiver 225 which receives, from the processing device, display information corresponding to the object after the recognition processing. This transmitter 224 may select a destination processing device, depending on the captured image. For example, the transmitter 224 may select a processing device capable of recognizing character strings, or a processing device capable of recognizing specific images. Therefore, various types of objects can be covered by using a processing device dedicated to each object.

Note that communication with the processing device may be performed using any one of or combination of Wi-Fi, Bluetooth, and mobile network communication.

### (Transparent Display 300)

The transparent display 300 can display an image determined by the image signal from the housing 200. That is, the transparent display 300 can display the image determined by the image signal over a sheet of paper arranged directly beneath the transparent display 300. The transparent display 300 is formed as, e.g., an organic EL display, which is a self-emitting flat display device requiring no backlight device.

### (Controller 230)

The controller 230 controls the operation of each component in the information processor 100. The controller 230 may include a memory which stores application software for image processing, and a CPU which executes this application software. In this case, the CPU executes the application software to control the image capture unit 210, the acquisition unit 220, and the transparent display 300.

he controller 230 instructs the image capture unit 210 to capture an object. Further, the controller 230 instructs the acquisition unit 220 to acquire display information corresponding to the object, and performs control to display, on the transparent display 300, image determined by the acquired display information. In this way, the image determined by the display information is displayed on the transparent display 300 together with the image of the object visible through the transparent display 300. Accordingly, the user can see the display information corresponding to the object without taking his/her eyes from the transparent display 300, which improves convenience.

In the configuration shown in FIG. 2, the housing 200 and the transparent display 300 wirelessly communicate with each other through communication units 226 and 227. Further, the transparent display 300 has a sensor 229 which detects the movement of the transparent display 300, and the signal from this sensor 229 is also transmitted through the communication unit 226.

The sensor 229 is an acceleration sensor, for example.

### (Image Processing Method According to an Embodiment)

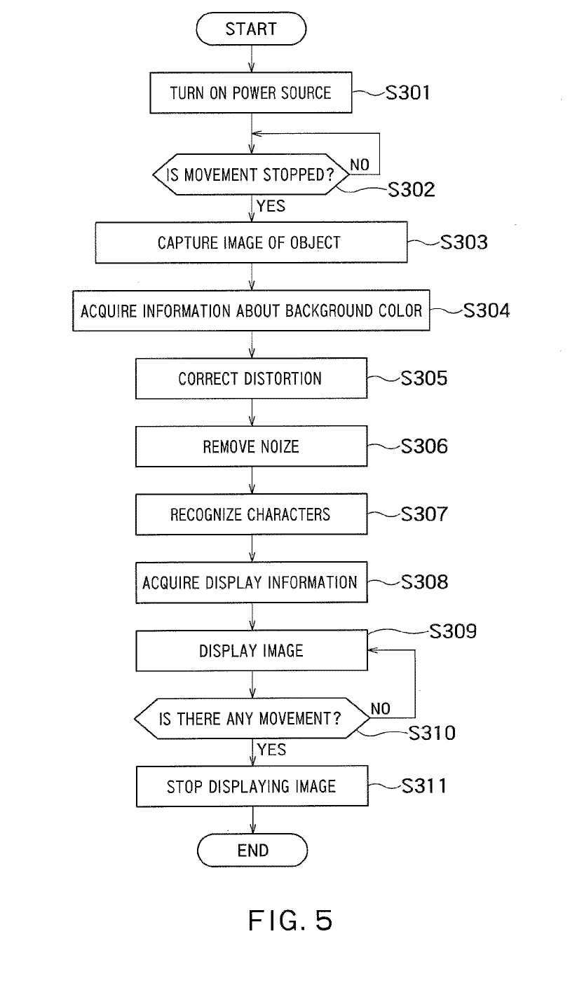

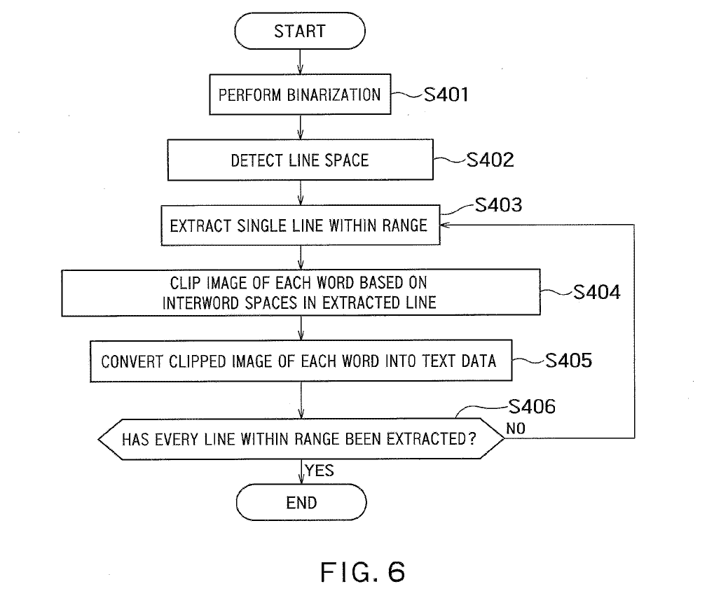

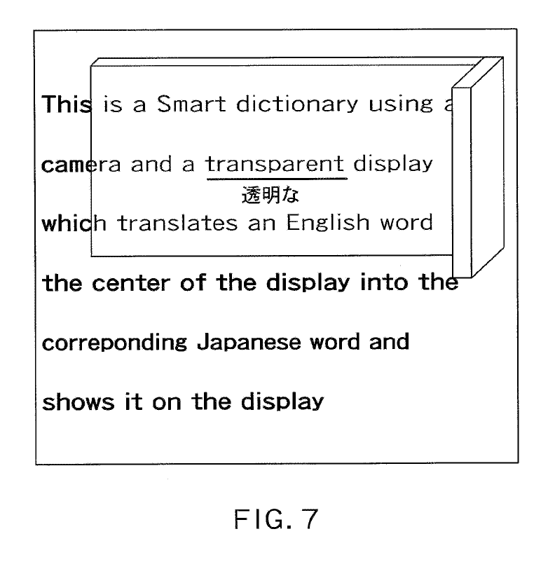

FIG. 5 is a flow chart showing an example of the process performed by an image processor and an information processor according to an embodiment. FIG. 6 is a flow chart for explaining the process to acquire a literal translation of an English word as display information when the transparent display 300 is placed on a sheet of paper with an English sentence written on it. FIG. 7 is a diagram showing a concrete example of displaying a literal translation of an English character string, which is an object, as display information.

Hereinafter, an image processing method according to an embodiment will be explained referring to FIG. 5. First, the information processor 100 is turned on (S301). The sensor 229 is also turned on at this timing.

The controller 230 judges whether a change in the image of an object visible through the transparent display 300 per unit time has a predetermined value Th1 or smaller, based on the output signal from the sensor 229 capable of detecting the movement of the transparent display 300 (S302). If the change has the predetermined value Th1 or smaller (in the case of YES), there is a strong possibility that the image capture unit 210 can capture a clear image, and thus the controller 230 instructs the image capture unit 210 to capture the image of the object. Upon receiving this instruction, the image capture unit 210 captures the image of the object, and transfers data of the captured image to the acquisition unit 220 (S303). Note that the image capture unit 210 may start capturing a moving image in synchronization with the timing of turning on the power. In this case, the controller 230 may judge whether a change in the image of the object per unit time has the predetermined value Th1 or smaller, based on the results obtained by detecting the movement of the moving image of image data captured in chronological order.

Next, the image recognition unit 221 obtains color information of at least one of hue, lightness, and chroma of the object and image surrounding the object, based on the image data (S304). Step S304 is provided to prevent the color of display information from being similar to the colors of the object and its background when displaying the display information on the transparent display 300.

Further, the image recognition unit 221 acquires image data removed of distortion (S305). In this step, distortion is removed from the image data using an inverse projective transformation matrix for example. The image recognition unit 221 removes noise from the image data removed of distortion (S306). Next, the image recognition unit 221 recognizes characters using the image data removed of noise, to generate text data (S307).

FIG. 6 is a flow chart showing a detailed example of the operating procedure corresponding to this Step S307.

The image recognition unit 221 performs binarization to separate the image data into character regions and the other regions (S401). For example, in this binarization, the value of 0 is given to each pixel having a predetermined pixel value or smaller, and the value of 1 is given to each of the other pixels.

In FIG. 1, pixels arranged in the X-direction constitute a “pixel row,” and a region having pixel rows consisting of pixels each having a value close to 0 is judged to be a line space. In this way, the image recognition unit 221 acquires position information of the line space (S402).

Next, the image recognition unit 221 extracts binarized data of pixel rows sandwiched between the line spaces, using the position information of the line spaces (S403).

Next, the image recognition unit 221 detects each space between words from the binarized data extracted at Step S403, and recognizes the binarized data sandwiched between interword spaces as a word to clip the binarized data of each word (S404).

Next, the image recognition unit 221 performs recognition processing on the binarized data of each word to convert it into text data (S405).

Next, the image recognition unit 221 judges, e.g., whether every word in the range 400 has been converted into text data (S406). If there is a line which has not been converted yet, Step

S403 and subsequent Steps should be repeated. The image recognition unit 221 ends Step S307 when all lines are completely converted.

By performing the steps of FIG. 6, the image recognition unit 221 can grasp line space, interword space, display position of each word, character size of each word, character gap of each word, etc. Such information is transmitted to the information acquisition unit 222 as auxiliary information. Further, this auxiliary information is also transmitted to the controller 230. Next, the information acquisition unit 222 searches the storage 223 using the generated text data, and acquires a literal translation of each English word as display information (S308).

The controller 230 instructs the transparent display 300 to display image determined by the display information using the auxiliary information (S309). For example, when the line space is larger than the character size, the controller 230 instructs to display the image of the literal translation in the line space under (in the Y-direction) the word. Here, the character size of the image may be the same as the character size of its corresponding word. Based on color information, the color of the image is set so that the display information can be distinguished from the image of the object and its background image.

Further, the character size may be changed depending on the line space. For example, it is desirable to display the image with a smaller character size depending on the size of the line space. In this case, the character may be displayed in a color (e.g., a complementary color of the object) which becomes more different from the color of the object as the character size is set smaller. This makes it easy to distinguish the object from the image even when the character of the image becomes smaller.

Further, when the line space has a predetermined value or smaller, the image may be displayed in a blank space other than the line space

Further, the word clarifying a character string by recognition processing may be displayed with underline image. Alternatively, the word may be enclosed, or the word or its background may be decorated. This makes it possible for the user to easily recognize the target of translation, which improves convenience.

Note that the controller 230 may display, on an external display (e.g., smartphone), detailed information on the usage of an English word corresponding to the object.

Next, the controller 230 judges whether a change in the image of an object visible through the transparent display 300 per unit time has a predetermined value Th2 or greater, based on the output signal from the sensor which detects the movement of the transparent display 300 (S310). If the change has the predetermined value Th2 or greater (in the case of YES), there is a strong possibility that a position gap is formed between the object and image, and thus the controller 230 stops displaying the image on the transparent display 300 (S311). This makes it possible to prevent the image which is not corresponding to the object from being displayed, and to prevent unnecessary image from being displayed in the recaptured image of the object.

The image capture unit 210, which continuously captures the image of the object when power is turned on in the example shown in the flow chart of FIG. 5, may capture the images of the object responding to a clear instruction from the user to capture the images, in order to reduce power consumption. In this case, this clear capturing instruction may be given by pushing or selecting a physical button provided on the transparent display 300 or the housing 200, or a logical button provided using software.

FIG. 7 shows an example where the range 400 within which the object can be extracted is limited to the center part of the transparent display 300. In this example, only the part showing the word of “TRANSPARENT” is included in the range 400 and treated as the target of literal translation.

### (Various Modification Examples)

In the example explained in the above embodiments, an object including character strings is treated as a target. However, the present embodiment can be applied when recognizing the image of an object including information other than character strings.

For example, the object may be animal, plant, human face, car, etc. In this case, the image recognition unit 221 may change the algorithm for recognizing the captured image of the object, depending on the type of the object. For example, when the object includes a human face, the recognition algorithm for human faces should be used. Further, plural pieces of identification information stored in the storage 223 should be also changed corresponding to the identification information obtained through the recognition algorithm. For example, when a human face is included in the object, it is desirable to store, in the storage 223, a plurality of typical face patterns as identification information.

Instead, when a human face is included in the object, the storage 223 may store a plurality of portraits corresponding to plural pieces of identification information, as display information. As stated above, the display information should not be necessarily limited to character information.

How to display the image on the transparent display 300 of FIG. 5 also may be changed depending on the object.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processor for processing an image of an object visible through a transparent display, comprising:
an acquisition unit to acquire display information corresponding to the object and obtained by performing recognition processing on the image; and
a controller to display, on the transparent display, the display information.

2. The image processor of claim 1, wherein the acquisition unit comprises:
an image recognition unit to perform recognition processing on the image to obtain identification information of the object;
a storage to store display information corresponding to each of plural pieces of identification information; and
an information acquisition unit to acquire, from the storage, the display information corresponding to the identification information of the object and obtained by the image recognition unit.

3. The image processor of claim 2,
wherein the object includes a character string, and
the image recognition unit performs recognition processing on an image of the character string to obtain the identification information.

4. The image processor of claim 3,
wherein the controller displays, on the transparent display, an image clarifying the character string by the recognition processing and the display information.

5. The image processor of claim 2,
wherein the object includes a character string,
the image recognition unit performs recognition processing on an image of the character string to acquire the identification information, and
the controller displays, on the transparent display, an image clarifying the character string and the display information.

6. The image processor of claim 1, further comprising an image capture unit to capture an image of an object visible through the transparent display.

7. The image processor of claim 3, wherein the controller displays, on the transparent display, the display information in a size depending on the size of the image of the character string visible through the transparent display.

8. The image processor of claim 3, wherein the controller displays the display information in at least one of a line space and a blank space provided near the image of the character string visible through the transparent display.

9. The image processor of claim 1, wherein the controller displays the display information in a color different from the color of the object visible through the transparent display and the color of background of the object.

10. The image processor of claim 6, wherein when a change in the image of the object per unit time has a predetermined value or greater, the controller instructs the image capture unit to stop capturing the image.

11. The image processor of claim 2, wherein the image recognition unit performs the recognition processing after correcting distortion of the image.

12. The image processor of claim 1 further comprising:
a transmitter to transmit the image to a processing device; and
a receiver to receive, from the processing device, the display information corresponding to the object and obtained by performing recognition processing on the image,
wherein the acquisition unit acquires the display information received by the receiver.

13. The image processor of claim 1, wherein the recognition processing is performed after distortion of the image is corrected by performing matching processing between a captured image of a calibration pattern visible through the transparent display and an image of the pattern before being captured.

14. The image processor of claim 2,
wherein the controller displays, on the transparent display, an image showing a range within which an object can be extracted, and
the image recognition unit extracts the object within the range.

15. The image processor of claim 14, wherein the controller displays, on the transparent display, the image showing the range so that an image capture unit which captures an image of an object visible through the transparent display comes into focus on the range.

16. The image processor of claim 6, wherein the image of the object visible through the transparent display is an image obtained by synthesizing a plurality of images captured while changing the focus of the image capture unit.

17. The image processor of claim 6, wherein when it is judged that a change in the image of the object visible through the transparent display per unit time has a predetermined value or smaller based on an output signal from a sensor capable of detecting movement of the transparent display, the controller instructs the image capture unit to capture the image of the visible object.

18. The image processor of claim 6, wherein when it is judged that a change in the image of the object visible through the transparent display per unit time has a predetermined value or greater based on an output signal from a sensor, the controller instructs the image capture unit which captures the image of the visible object to stop capturing the image of the visible object.

19. An information processor comprising:
a transparent display;
an image capture unit to capture an image of an object visible through the transparent display;
an acquisition unit to acquire display information corresponding to the object and obtained by performing recognition processing on the image; and
a controller to display, on the transparent display, the display information.

20. The information processor of claim 19, further comprising:
a housing having the image capture unit, the acquisition unit, and the controller, the housing being rotatable with respect to the transparent display,
wherein the acquisition unit acquires correction data for correcting distortion of the image caused depending on a rotational angle of the housing.
